(19) United States
(12) Patent Application Publication
(10) Pub. No.: US 2023/0198125 A1
(43) Pub. Date: Jun. 22, 2023

(54) ELECTRONIC DEVICE

(71) Applicant: HUAWEI TECHNOLOGIES CO., LTD., Shenzhen (CN)

(72) Inventors: Jiahui Chu, Shanghai (CN); Xin Chen, Shanghai (CN)

(21) Appl. No.: 17/926,950

(22) PCT Filed: May 6, 2021
(86) PCT No.: PCT/CN2021/091930

§ 371 Date: Nov. 21, 2022

(30) Foreign Application Priority Data
May 20, 2020 (CN) 202010431961.3

(51) Int. Cl. H01Q 1/24; H01Q 1/36; H04M 1/02

(52) U.S. Cl. CPC H01Q 1/243; H01Q 1/36; H04M 1/0264

(57) ABSTRACT

An electronic device includes an antenna and a metal structure accommodated in a housing. In a first direction, the metal structure, at least a part of the antenna, and a part of the housing are sequentially arranged. The metal structure is provided with a non-closed slot, and in the first direction, the slot penetrates through the metal structure. The metal structure includes a first surface facing the antenna in the first direction, a vertical projection of the antenna on the first surface is an antenna projection region, and the slot extends from an edge of the first surface to the inside of the first surface and passes through the antenna projection region, so that in a working state of the antenna, an induced current that is in a same direction as a current on the antenna is formed on the first surface.

### CROSS-REFERENCE TO RELATED APPLICATIONS

This application is a National Stage of International Patent Application No. PCT/CN2021/091930, filed on May 6, 2021, which claims priority to Chinese Patent Application No. 202010431961.3, filed on May 20, 2020, both of which are hereby incorporated by reference in their entireties.

### TECHNICAL FIELD

This application relates to the field of communication technologies, and in particular, to an electronic device having an antenna.

### BACKGROUND

With development of communication technologies, an electronic device has increasingly more functions and an increasing quantity of internal components and communication antennas. To ensure lightness and thinness of the electronic device, space occupied by various internal components and communication antennas needs to be compressed. In this case, a spacing between a metal structure and an antenna inside the electronic device is small. It can be learned from the Lenz's law that an induced current is generated on a metal structure close to the antenna, and a direction of the induced current on the metal structure is opposite to a direction of a current on the antenna. In this way, working performance of the antenna is weakened to some extent.

Therefore, an electronic device is urgently needed to change the adverse impact of an induced current on a metal structure on a magnetic field of an antenna, thereby effectively improving working performance of the antenna.

### SUMMARY

This application provides an electronic device that can change the adverse impact of an induced current on a metal structure inside the electronic device on a magnetic field of an antenna, thereby effectively improving working performance of the antenna.

The electronic device in an embodiment of this application includes a housing, and an antenna and a metal structure that are accommodated in the housing. The metal structure, at least a part of the antenna, and a part of the housing are sequentially arranged in a first direction. The antenna is attached to the metal structure, or an insulation medium exists between the metal structure and the antenna. The insulation medium may be air, that is, the antenna may be considered as a suspended structure relative to the metal structure. The insulation medium may alternatively be a non-metal mechanical part. It may be understood that, no other metal piece is included between the antenna and the metal structure. The metal structure is provided with a non-closed slot, and the slot penetrates through the metal structure in the first direction. The metal structure includes a first surface facing the antenna in the first direction, a vertical projection of the antenna on the first surface is an antenna projection region, and the slot extends from an edge of the first surface to the inside of the first surface, and passes through the antenna projection region. In a working state of the antenna, an induced current that is in a same direction as a current on the antenna is formed on the first surface. That the slot penetrates through the metal structure in the first direction may be understood as that a through slot is provided on the metal structure, and the through slot is in a form of penetrating through the metal structure in the first direction. In other words, a part of the metal structure is cut off in the first direction, to change current distribution on the metal structure in the working state of the antenna. That “the slot extends from an edge of the first surface to the inside of the first surface and passes through the antenna projection region” may be understood as: the slot intersects the antenna projection region, and the slot forms an opening at the edge of the first surface. An end that is of the slot and that is away from the opening is located on a side that is of the antenna projection region and that is away from the opening. In other words, there is a part of the slot on each opposite side of the antenna projection region. It may also be understood that the antenna gets across or crosses at least a part of the slot.

The first surface may be any outer surface of the metal structure. A location of the first surface on the metal structure is not specifically limited herein, but a relative location relationship between the first surface and the antenna is mainly described. The first surface faces the housing, and the antenna is located between the first surface and the housing. When observed in a direction perpendicular to the first surface, the antenna at least partially overlaps the metal structure. It may be understood that the metal structure, at least a part of the antenna, and a part of the housing are sequentially arranged in the first direction. In this structure, the first surface directly faces the antenna in the first direction.

In the first direction, that is, in a direction perpendicular to the first surface, the slot penetrates through the metal structure. It may be understood that if the slot does not penetrate through the metal structure in the first direction, on the metal structure, a flow direction of the induced current does not change at a position at which the slot does not penetrate, and the induced current still flows in the original direction. Therefore, adverse impact of the induced current on a magnetic field of the antenna cannot be reduced. On the first surface, the slot extends from an edge of the first surface to the inside of the first surface. In this structure, the edge of the slot is connected to the edge of the first surface, so that the slot is a non-closed slot. In the following, a description of a related position relationship may be understood in a same manner.

A vertical projection of the antenna on the first surface is an antenna projection region, and the slot extends from an edge of the first surface to the inside of the first surface and passes through the antenna projection region. When the antenna and the slot are in the foregoing position relationship, it may be understood that the antenna projection region intercepts the slot, a part of the slot is located outside the antenna projection region and is connected to the edge of the first surface, and another part of the slot is located inside the antenna projection region. Due to continuity of a current, an induced current generated on the metal structure close to the antenna inevitably flows along two paths when passing through the slot. One induced current flow path is: flowing along an edge of a part that is of the slot and that is located outside the antenna projection region to an edge of the metal structure, and the other induced current flow path is: flowing along an edge of a part that is of the slot and that is located inside the antenna projection region. It may be understood that, on the foregoing two paths, a flow direction of the induced current is consistent with a flow direction of the current on the antenna. In other words, in this structure, induced currents that are in a same direction as the current on the antenna are generated at positions that are located inside and outside the antenna projection region on the metal structure. In this way, working performance of the antenna is ensured to be not weakened, and is enhanced to some extent.

According to the electronic device in this application, when the antenna is in an operating frequency band, an induced current is generated on the metal structure. It can be learned according to the Lenz's law that the induced current has a direction that a magnetic field of the induced current always hinders a change of a magnetic flux that causes the induced current. Therefore, a direction of the induced current generated on the metal structure close to the antenna is opposite to the direction of the current on the antenna. As the magnetic field of the induced current offsets with part of the magnetic field of the antenna, working performance of the antenna is weakened to some extent. Due to existence of the slot on the metal structure, an induced current passing through the slot separately flows along the foregoing two paths due to continuity of the current. Directions of the induced currents on the foregoing two paths are consistent with the direction of the current on the antenna. In this way, adverse impact of the induced current on the magnetic field of the antenna can be reduced, and working performance of the antenna can be effectively improved.

In an embodiment, the antenna projection region forms enclosing space, and a part of the slot is located in the enclosing space. When the antenna is an enclosing structure, a corresponding signal transmission function can be better met. In this structure, a vertical projection of the antenna on the first surface inevitably forms enclosing space, and the part that is of the slot and that is located inside the antenna projection region is located in the enclosing space and does not extend beyond the enclosing space. It may be understood that when the part that is of the slot and that is located inside the antenna extends beyond the enclosing space, an induced current generated on another metal inside the enclosing space cannot be offset. In this case, working performance of the antenna is weakened. Therefore, the part that is of the slot and that is located inside the antenna needs to be limited within the enclosing space, to ensure that a magnetic field generated by the induced current on the metal structure has a better gain effect on the magnetic field of the antenna.

It may be understood that the antenna may have a plurality forms of enclosing structures, including but not limited to a semi-enclosing structure or a full-enclosing structure. The projection region of the antenna on the first surface also has a plurality of forms of enclosing space, including but not limited to semi-enclosing space or full-enclosing space.

In an embodiment, the part that is of the slot and that is located in the enclosing space includes a connection part and an extension part. The connection part extends between an inner edge of the antenna projection region and the extension part, and in an extension direction perpendicular to the connection part, a size of the extension part is greater than a size of the connection part. In the foregoing structure, because the extension part has a larger size, the part that is of the slot and that is located in the enclosing space has a larger area. Therefore, a path for flowing an induced current on an edge of the slot in this part is longer, and a range of a magnetic field generated by the induced current is larger. It can be learned from the foregoing description that a flow direction of the induced current on the part that is of the slot and that is located in the enclosing space is the same as the flow direction of the current on the antenna. Therefore, when the range of the magnetic field generated by the induced current on this part is larger, the induced current on this part has a better gain effect on the magnetic field of the antenna. In this way, the working performance of the antenna is further improved.

In an embodiment, the slot includes a first segment, a third segment, and a second segment that are sequentially connected. The first segment is located between the antenna projection region and the edge of the first surface. The third segment is located in the antenna projection region. The second segment is located in the enclosing space. The second segment includes the connection part and the extension part, and the connection part is connected between the third segment and the extension part. The first segment, the third segment, and the connection part are all in a straight line shape and collinear. The second segment is the part that is of the slot and that is located in the enclosing space in the foregoing implementation. When observed in the first direction, the first segment is located outside the antenna projection region and is connected to the edge of the first surface. The second segment is located in the enclosing space of the antenna projection region, the first segment is connected to the second segment through the third segment, and the third segment is located in the antenna projection region. When the antenna is in an operating frequency band, an induced current generated on the metal structure close to the antenna inevitably flows along two paths. One induced current flow path is: flowing along an edge of the first segment to an edge of the metal structure, and the other induced current flow path is: flowing along an edge of the second segment. It may be understood that, on the foregoing two paths, a flow direction of the induced current is consistent with a flow direction of the current on the antenna. In other words, in this structure, induced currents that are in a same direction as the current on the antenna are generated at positions that are located inside and outside the antenna on the metal structure. In this way, working performance of the antenna is further ensured to be not weakened, and is enhanced to some extent. The second segment is located in the enclosing space, and includes the connection part and the extension part. The connection part is connected between the third segment and the extension part. It can be learned from the description of the foregoing implementation that, in an extension direction perpendicular to the connection part, a size of the extension part is greater than a size of the connection part, and the extension part has a larger size, so that the part that is of the slot and that is in the enclosing space has a larger area. In this way, working performance of the antenna is further improved, and a specific principle is not described herein again.

In the electronic device in an embodiment of this application, the metal structure is not limited to a specific metal structure, and may alternatively be a metal material region on any component. Because internal space of the electronic device is small, a distance between the metal material region on any one of the foregoing components and the antenna is small, and there is a partial overlap between the metal material region and the antenna in the first direction, an induced current whose direction is opposite to the direction of the current on the antenna is generated in the metal material region. In this way, working performance of the antenna is affected. Disposing the slot in the metal material region can reduce adverse impact of the induced current on the antenna. In addition, directions of some induced currents are changed, so that in some regions of the metal structure, the directions of the induced currents are the same as the direction of the current on the antenna. In this way, working performance of the antenna is improved to some extent.

In an embodiment, the electronic device further includes an electronic component, slot opening cannot be performed on the electronic component, and the metal structure is disposed between the antenna and the electronic component. The slot is disposed on the metal structure to form an induced current that is in the same direction as the current on the antenna, to reduce impact of the electronic component on the antenna. It should be noted that there may be some electronic components that cannot be slotted in the electronic device, for example, a battery. Slot opening may destroy a function of the electronic component. However, a metal material on the electronic component also affects performance of the antenna. In this case, the metal structure may be additionally disposed between the electronic component and the antenna, and in an operating frequency band of the antenna, the metal structure and the electronic component are in electrical connection isolation. It may be understood that the electrical connection isolation includes but is not limited to physical insulation isolation, and isolation in the corresponding operating frequency band may be further performed by using a component having a filter feature. If no electrical connection isolation is formed herein, after the metal structure is connected to the electronic component, a “ground plane” is formed. In this case, the slot on the metal structure is useless.

It can be learned from the foregoing description that, because internal space of the electronic device is small, the metal structure and the antenna are disposed close to each other and at least partially overlap in the first direction. According to the foregoing structure requirement, a non-closed slot body extending from an edge of the metal structure to the inside of the metal structure is disposed on the metal structure, to form the slot. In the presence of the slot, an induced current generated at a position close to the antenna on the metal structure separately flows through the edge of the slot and the edge of the metal structure while passing through the slot. In addition, a direction of the induced current passing through the edge of the slot and the edge of the metal structure is the same as the direction of the current on the antenna. In this way, working performance of the antenna is effectively improved, adverse impact of the electronic component on performance of the antenna is offset, and a normal function of the electronic component is ensued without opening a slot on the electronic component.

In an embodiment, a mainboard is disposed inside the electronic device, and the metal structure is a ground plane on the mainboard. It can be learned from the foregoing description that, because internal space of the electronic device is small, the ground plane on the mainboard is close to the antenna, and the ground plane and the antenna at least partially overlap in the first direction. An induced current whose direction is opposite to the direction of the current on the antenna is generated on the ground plane of the mainboard. In other words, the ground plane is the metal structure in the electronic device in this application, and the slot is provided on the ground plane, so that adverse impact of the induced current on the ground plane on working performance of the antenna can be effectively reduced. A direction of the induced current on the ground plane and a working principle of the slot are the same as the direction and the principle described in the foregoing implementation, and details are not described again. Generally, the mainboard is of a multi-layer structure, and has a plurality of ground planes. The plurality of ground planes are all disposed close to and at least partially overlap the antenna. In this structure, slot opening needs to be performed on each ground plane, so as to ensure that an induced current on the ground plane does not greatly affect the working performance of the antenna. In addition, after slot opening is performed on the mainboard, a required component may be placed in a non-slotted region on the mainboard. This can also meet a corresponding function requirement and does not affect other functions of the electronic device.

In an embodiment, a camera module is disposed inside the electronic device. The camera module includes a camera housing and a camera body located inside the camera housing. The metal structure is the camera housing, and an insulation material is disposed between the camera housing and the camera body. Generally, the camera housing is made of a metal material. Under the same reason as that described in the foregoing implementation, the camera housing is the metal structure in the electronic device in this application. The slot is provided on the camera housing, sot that adverse impact of an induced current on the camera housing on working performance of the antenna can be effectively reduced. A direction of the induced current on the camera housing and a function principle of the slot are the same as the direction and the principle described in the foregoing implementations, and details are not described again. It should be noted that, slot opening may not be performed on the camera body inside the camera housing, to avoid impact on a photographing function of the camera. However, insulation processing should be performed between the camera housing and the camera body, to avoid impact of the camera body on the antenna, for example, an insulation material is disposed between the camera body and the camera housing. In this way, the photographing function of the camera is not affected, and adverse effect on working performance of the antenna is avoided.

In an embodiment, a metal shielding case and a non-metal shield layer are disposed inside the electronic device. The metal shielding case is configured to shield an electronic component, the metal structure is the metal shielding case, and the non-metal shield layer is connected to the metal shielding case and covers the slot, so that the non-metal shield layer and the metal shielding case jointly form an electromagnetic interference protection structure of the electronic component. The metal shielding case is configured to shield impact of an external electromagnetic wave on an internal circuit and/or shield radiation of an electromagnetic wave generated inside. Generally, the metal shielding case is integrally made of stainless steel and a copper-nickel-zinc alloy. Under the same reason as that described in the foregoing implementation, the metal shielding case is the metal structure in the electronic device in this application. The slot is provided on the metal shielding case, so that adverse impact of an induced current on the metal shielding case on working performance of the antenna can be effectively reduced. A direction of the induced current on the metal shielding case and a function principle of the slot are the same as the direction and the principle described in the foregoing implementation, and details are not described again. It should be noted that, opening the slot on the metal shielding case inevitably affects shielding performance of the metal shielding case to some extent. Therefore, a non-metal shield layer needs to be disposed at the slot on the metal shielding case, and the non-metal shield layer is connected to the metal shielding case to cover the slot. In this way, a shielding effect of the shielding case can be ensured, and adverse impact on working performance of the antenna can be avoided.

In conclusion, it can be learned that the metal structure may be a metal part on any component, and in the first direction, the metal part at least partially overlaps the antenna. The metal structure is not limited to the several implementations listed above, and may alternatively be a metal part on another component. This is not specifically limited herein.

In an embodiment, the electronic device further includes a magnetic piece. The magnetic piece is disposed on a side that is of the metal structure and that is away from the antenna, and is configured to isolate the metal structure from another metal piece in the electronic device. The magnetic piece is disposed at a position at which the metal structure is away from the antenna, and is mainly configured to isolate the metal structure, so as to prevent the metal structure from being connected to another metal piece. It may be understood that if the metal structure is connected to another metal piece, the metal structure and the another metal piece jointly form an integer. The slot on the original metal structure may be filled by another metal piece, or become a closed slot due to a structure change; or for some other reasons, a direction of the induced current cannot be changed, and adverse impact on working performance of the antenna cannot be avoided.

The magnetic piece is made of ferrite, and the ferrite is a metal oxide having a ferromagnetic property. In terms of an electrical property, the ferrite has resistivity much larger than that of metal and alloy magnetic materials, and has a higher dielectric property. The magnetic property of the ferrite also shows that it has high magnetic permeability on a high frequency. Therefore, the ferrite has become a widely used nonmetallic magnetic material in the field of high frequency and weak current. According to the formula B=μ·H, B represents magnetic induction intensity, μ represents magnetic permeability, and H represents magnetic field intensity. When the magnetic field intensity H remains unchanged, because the magnetic permeability μ of the ferrite is generally large, the magnetic induction intensity B of the ferrite is large. This indicates that the ferrite has a gathering function on a magnetic field. Therefore, the magnetic piece can not only isolate the magnetic field, but also can gather the magnetic field. It should be noted that the magnetic piece is not limited to being made of ferrite, and may also be made of any other magnetic material that meets a corresponding function requirement. This is not specifically limited herein.

It should be noted that the magnetic piece may also be disposed between the antenna and the metal structure at the same time. The magnetic piece is disposed between the antenna and the metal structure, and a magnetic field gathering function of the magnetic piece is mainly used. After the magnetic piece is additionally deposed at the position, a magnetic field is mainly gathered on the magnetic piece, and a closed curve is formed after the magnetic field passes through the magnetic piece. The magnetic piece is disposed between the antenna and the metal structure, so that a magnetic field can be gathered, and impact of the metal structure on the magnetic field of the antenna is reduced. In this way, the antenna is ensured to have good working performance. Because the magnetic piece is disposed between the antenna and the metal structure, a magnetic field gathering function of the magnetic piece is mainly used instead of an isolation function of the magnetic piece. Therefore, the magnetic piece herein does not need to cover and isolate the entire metal structure. To reduce costs, in a specific implementation, a shape and a size of the magnetic piece between the antenna and the metal structure match a shape and a size of the antenna, that is, for the magnetic piece located between the antenna and the metal structure in a direction perpendicular to the first surface, a projection profile of the magnetic piece on the first surface coincides with a projection profile of the antenna on the first surface. In this way, the magnetic piece covers only a region in which the antenna is located. In this structure, the magnetic piece can gather the magnetic field, thereby reducing adverse impact of the metal structure on the antenna. In addition, a coverage area of the magnetic piece is further controlled, thereby reducing process costs.

It may be understood that, in an actual application, according to different working principles of the antenna, when the antenna with different operating frequency bands is in a corresponding operating frequency band, requirements for the metal structure are also different, for example, the metal structure is ungrounded, or the metal structure is grounded. Generally, for some antennas with a low operating frequency band, that is, the antenna with an operating frequency band less than 100 M, for example, a near field communication (Near Field Communication, NFC) antenna, when the antenna works, radiation needs to be performed by using metal. Therefore, when the antenna is in an operating frequency band, the metal structure is required to be suspended and not connected to the mainboard. When the metal structure is not suspended and connected to the mainboard, the metal structure becomes a ground plane, so that a radiation effect cannot be achieved, and the antenna cannot be in a normal working state. For a high-frequency antenna, that is, an antenna whose operating frequency band is greater than 500 M, when the antenna is in its operating frequency band, for example, a 2nd-generation mobile communication (2nd-Generation, 2G) frequency band, a 3rd-generation mobile communication (3rd-Generation, 3G) frequency band, a 4th-generation mobile communication (4th-Generation, 4G) frequency band, a 5th-generation mobile communication (5th-Generation, 5G) frequency band, and a Wi-Fi frequency band, a GPS frequency band or the like, the metal structure is required to be grounded. When the metal structure is in the high frequency band, if the metal structure is suspended and ungrounded, working performance of the antenna corresponding to the metal structure is affected to some extent. Therefore, the metal structure needs to be grounded, so that the metal structure is used as a ground plane. In this way, impact of the metal structure on the high-frequency antenna is avoided.

In the electronic device in this application, the antenna mainly refers to an antenna whose operating frequency band is less than 100 M. Therefore, it needs to be ensured that the metal structure is ungrounded.

In an embodiment, in the electronic device in this application, the electronic device further includes a mainboard. The metal structure is disposed between the mainboard and the antenna in a stacked manner, a magnetic piece is disposed between the mainboard and the metal structure, and a suspended ungrounded architecture is formed between the metal structure and the mainboard. In this structure, the metal structure is suspended and ungrounded, so that a requirement of the antenna on the metal structure in a corresponding operating frequency band of the antenna is met.

In an embodiment, the electronic device further includes a mainboard. The metal structure is disposed between the mainboard and the antenna in a stacked manner, a magnetic piece is disposed between the mainboard and the metal structure, and the metal structure is electrically connected to a ground plane of the mainboard by using a filter component. In an operating frequency band of the antenna, the filter component has a high resistance feature, so that an isolation signal is transmitted from the antenna to the mainboard. In this structure, a requirement that the metal structure of the antenna is ungrounded in a corresponding operating frequency band of the antenna can also be met. In addition, when a high-frequency antenna whose operating frequency band is greater than 500 M exists in the electronic device, the filter may be set to be in a low resistance feature in a frequency band greater than 500 M, so that the metal structure and the ground plane of the mainboard are connected in a high frequency band. In this way, a requirement that the metal structure of the high-frequency antenna is grounded in a corresponding operating frequency band of the high-frequency antenna is also met. In this way, working performance of the antenna and the high frequency antenna in respective working frequency bands are ensured at the same time.

It may be understood that, in this application, an operating frequency band of the antenna is defined to be less than 100 M, and an operating frequency band of the high-band antenna is defined to be greater than 500 M. For different operating cases, specific operating frequency bands of the antenna and the high-band antenna may be divided differently, so as to perform different processing by using different features of different frequency bands. In addition, the filter may be any shape or structure that meets a corresponding function requirement. This is not specifically limited herein either. The antenna in the electronic device in this application includes but is not limited to a near field communication antenna, and has a plurality of structures. Details are not described herein again.

### BRIEF DESCRIPTION OF DRAWINGS

To describe technical solutions in embodiments of this application more clearly, the following describes the accompanying drawings used in embodiments of this application.

FIG. 1a is a schematic diagram of a structure of an electronic device according to an embodiment of this application;

FIG. 1b is a schematic diagram of a fastening structure of a metal support in the electronic device shown in FIG. 1a;

FIG. 2a is a schematic diagram of a structure of an antenna-related component in a conventional electronic device;

FIG. 2b is a schematic diagram of current distribution on the antenna-related component shown in FIG. 2a;

FIG. 3a is a schematic diagram of a structure of another antenna-related component in a conventional electronic device;

FIG. 3b is a schematic diagram of current distribution on the antenna-related component shown in FIG. 3a;

FIG. 4a is a schematic diagram of a structure of an antenna-related component in the electronic device shown in FIG. 1a in an embodiment;

FIG. 4b is a schematic diagram of a structure of the antenna-related component shown in FIG. 4a in another embodiment;

FIG. 4c is a schematic diagram of an antenna projection region and enclosing space in the antenna-related component shown in FIG. 4b;

FIG. 5a is a schematic diagram of a structure of an antenna-related component in the electronic device shown in FIG. 1a in another embodiment;

FIG. 5b is a schematic diagram of a structure of the antenna-related component shown in FIG. 5a in another embodiment;

FIG. 5c is a schematic diagram of an antenna projection region and enclosing space in the antenna-related component shown in FIG. 5b;

FIG. 6a is a schematic diagram of current distribution on the antenna-related component shown in FIG. 4b;

FIG. 6b is a schematic diagram of current distribution on the antenna-related component shown in FIG. 5b;

FIG. 7a is a sectional view of the antenna-related component shown in FIG. 4b in an A-A direction;

FIG. 7b is a sectional view of the antenna-related component shown in FIG. 5b in a B-B direction;

FIG. 8a is a schematic diagram of a structure when a magnetic piece is applied to the antenna-related component shown in FIG. 7a;

FIG. 8b is a schematic diagram of a structure when a magnetic piece is applied to the antenna-related component shown in FIG. 7b;

FIG. 9a is a schematic diagram of a structure of the antenna-related component shown in FIG. 8a in an embodiment;

FIG. 9b is a schematic diagram of a structure of the antenna-related component shown in FIG. 8b in another embodiment;

FIG. 10a is a diagram of transmission coefficient simulation performed by using the antenna-related component in FIG. 9a;

FIG. 10b is a diagram of comparison between transmission coefficient results in FIG. 10a;

FIG. 11a is a diagram of transmission coefficient simulation performed by using the antenna-related component in FIG. 9b;

FIG. 11b is a diagram of comparison between transmission coefficient results in FIG. 11a;

FIG. 12a is a schematic diagram of a structure of a metal structure in an electronic device according to an embodiment of this;

FIG. 12b is a schematic diagram of a structure of a metal structure in an electronic device according to an embodiment of this application; and

FIG. 12c is a schematic diagram of a structure of a metal structure in an electronic device according to an embodiment of this application.

### DESCRIPTION OF EMBODIMENTS

The following describes the technical solutions in embodiments of this application with reference to the accompanying drawings in embodiments of this application. It is clear that the described embodiments are merely some but not all of embodiments of this application. All other embodiments obtained by a person of ordinary skill in the art based on embodiments of this application without creative efforts shall fall within the protection scope of this application.

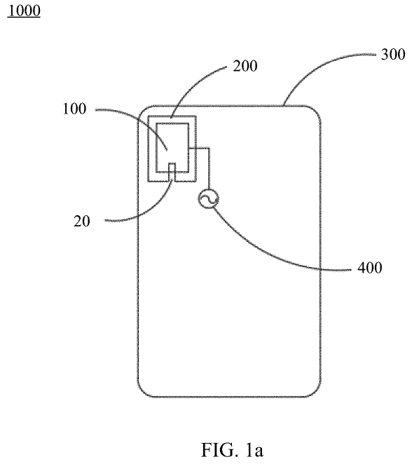

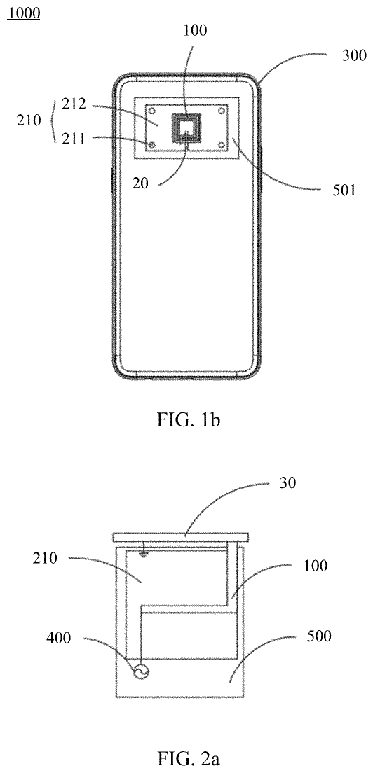

FIG. 1a is a schematic diagram of a structure of an electronic device 1000 according to an embodiment of this application.

The electronic device 1000 provided in this embodiment of this application includes but is not limited to a mobile phone, a POS machine, a computer, or a tablet computer, or may be another electronic device 1000 having a corresponding function. This is not specifically limited herein. The electronic device 1000 provided in this embodiment of this application includes an antenna 100, a metal structure 200, a housing 300, and a radio frequency module 400. Accommodating space is provided in the housing 300, and the antenna 100, the metal structure 200, and the radio frequency module 400 are all assembled in the accommodating space. The radio frequency module 400 is electrically connected to the antenna 100, and is configured to receive and transmit electromagnetic signals from and to the antenna 100. The antenna 100 radiates an electromagnetic wave based on the received electromagnetic signal or sends an electromagnetic signal to the radio frequency module 400 based on the received electromagnetic wave, so as to implement signal reception and transmission. Because the electronic device 1000 needs to meet market requirements of lightness, thinness, and miniaturization, the accommodating space inside the housing 300 is small. The metal structure 200 partially overlaps the antenna 100 with a small spacing. When the antenna 100 is in a working state, an induced current is generated on the metal structure 200. This causes adverse impact on working performance of the antenna 100.

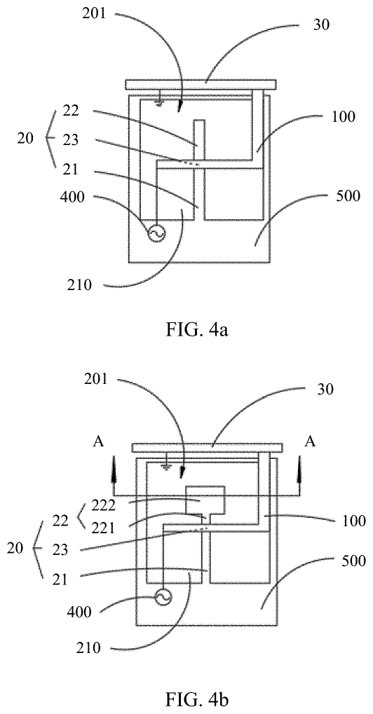

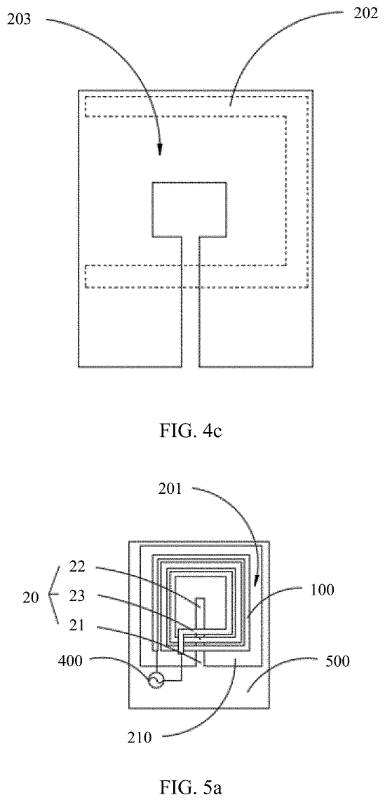

In the electronic device 1000 provided in this embodiment of this application, the metal structure 200, at least a part of the antenna 100, and a part of the housing 300 are sequentially arranged in a first direction. Refer to FIG. 1a. The first direction may be understood as a direction perpendicular to a paper. The metal structure 200 and the antenna 100 may be in an attachment relationship, that is, the antenna 100 is attached to the metal structure 200. Alternatively, in the first direction, there is an insulation medium between the metal structure 200 and at least a part of the antenna 100. In this region, no other metal piece (or a mechanical part including a metal material, for example, a camera module or a circuit board including a metal layer) is disposed. The insulation medium may be air, that is, there may be air between the metal structure 200 and the antenna 100. In other words, the antenna is in a suspended state relative to the metal structure. The insulation medium may alternatively be another non-metal mechanical part. The metal structure 200 is provided with a non-closed slot 20, and in the first direction, the slot 20 penetrates through the metal structure 200. The metal structure 200 includes a first surface 201 facing the antenna 100 in the first direction (as shown in FIG. 4a), and a vertical projection of the antenna 100 on the first surface 201 is an antenna projection region. The slot 20 extends from an edge of the first surface 201 to the inside of the first surface 201 and passes through the antenna projection region. In a working state of the antenna 100, an induced current that is in a same direction as a current on the antenna 100 is formed on the first surface 201. Due to existence of the non-closed slot 20, directions of induced currents in some regions on the metal structure 200 are consistent with the direction of current on the antenna 100, that is, the directions are all clockwise directions or anticlockwise directions. In this way, adverse impact of the induced current on a magnetic field of the antenna 100 is reduced, and working performance of the antenna 100 is effectively improved.

The housing 300 may be a non-metal housing, and the housing 300 is located on a radiation path of the antenna 100. In another embodiment, the housing 300 may alternatively be a metal housing. However, some non-metallic regions need to be disposed on the metal housing, and the non-metallic regions are configured to provide a channel for receiving and transmitting signals. It may be understood that signal reception and transmission of the antenna 100 are implemented in a manner in which an antenna gap is disposed on the housing 300.

The radio frequency module 400 (AF module) is a circuit that can transmit and/or receive a radio frequency signal, such as a transmitter and/or receiver (T/R). The antenna 100 includes but is not limited to a near field communication (NFC) antenna 100, or may be another type of antenna 100. Details are not described herein one by one. For ease of description, the near field communication antenna 100 is used as an example for a detailed description in this application.

The first direction is a direction in which the metal structure 200, at least a part of the antenna 100, and a part of the housing 300 are sequentially arranged and overlapped. The metal structure 200 includes a first surface 201, the first surface 201 faces the housing 300, and the antenna 100 is located between the first surface 201 and the housing 300. In the first direction, the antenna 100 directly faces the first surface 201. The first surface 201 may be planar, or the first surface 201 may be non-planar, for example, may have an uneven part, or may be an arc surface. A specific form of the first surface 201 is not limited in this application.

The antenna 100 at least partially overlaps the metal structure 200, that is, at least a part of the antenna 100 is located between the first surface 201 and the housing 300, and sandwich space is formed between the first surface 201 and the housing 300. The antenna 100 may be completely accommodated in the sandwich space, or a part of the antenna 100 extends into the sandwich space and is disposed opposite to the first surface 201. A part of the antenna 100 is located outside the sandwich space and is not disposed opposite to the first surface 201. In addition, the non-closed slot 20 means that in a direction perpendicular to the first surface 201, the slot 20 penetrates through the metal structure 200, and on the first surface 201, the slot 20 extends from an edge of the first surface 201 to the inside of the first surface 201.

A vertical projection of the antenna 100 on the first surface 201 is an antenna projection region, and the slot 20 extends from an edge of the first surface 201 to the inside of the first surface 201 and passes through the antenna projection region. It may be understood that the vertical projection region of the antenna 100 on the first surface 201 intercepts the slot 20, a part of the slot 20 is located outside the projection region of the antenna 100, and is connected to an edge of the first surface 201, and another part of the slot 20 is located inside the projection region of the antenna 100. Due to continuity of a current, an induced current generated on the metal structure 200 close to the antenna 100 inevitably flows along two paths when passing through the slot 20. One induced current flow path is: flowing along an edge of a part that is of the slot 20 and that is located outside the projection region of the antenna 100 to an edge of the metal structure 200, and the other induced current flow path is: flowing along an edge of a part that is of the slot 20 and that is located inside the projection region of the antenna 100. It may be understood that, on the foregoing two paths, a flow direction of the induced current is consistent with a flow direction of a current on the antenna 100. In other words, in this structure, induced currents that are in a same direction as the current on the antenna 100 are generated at positions on the metal structure 200 that are located inside and outside the antenna 100. In this way, working performance of the antenna 100 is ensured to be not weakened, and is enhanced to some extent.

It should be noted that the metal structure 200 is not limited to a metal support or a metal plate that is disposed in a stacked manner with an antenna in the electronic device, and may alternatively be a metal material region on any component (for example, a camera or a shielding cover) in the electronic device.

Refer to FIG. 1B. A metal support 210 is used as an example. The metal support 210 is an integrated structure. The metal support 210 includes support pins 211 and a support plate 212. The support pins 211 are attached to a circuit board 501 by using screws, and the support plate 212 is configured to carry the antenna 100. The antenna 100 may be fixedly attached to a surface that is of the support plate 212 and that is away from the circuit board 501. An area of the support plate 212 may be larger than an outer contour of the antenna 100. All or a part of the antenna 100 overlaps the support plate 212. It may be understood that the support pins 211 may alternatively be welded and fastened to the circuit board 501, so that the metal support 210 and the circuit board 501 are more firmly fastened. It should be noted that a connection manner between the metal support 210 and the circuit board 501 is not limited to the foregoing two, and may be any connection manner that can meet a corresponding function. A structure of the metal support 210 is not limited to an integrated structure, but may alternatively be a split structure or any structure meeting a corresponding function. This is not specifically limited herein. The circuit board 501 may be a circuit board 501 on a mainboard 500, or may be a circuit board 501 connected to the mainboard 500 by using an FPC. In addition, after the metal support 210 is fastened to the circuit board 501, there is specific space between the metal support 210 and the circuit board 501. Some electronic components may be disposed in the space, and the electronic components are pressed and stabilized on the circuit board 501 by using the metal support 210. This improves structural stability.

Because accommodating space inside the housing 300 is small, a spacing distance between a metal material region on any component and the antenna 100 is small, and the metal material region at least partially overlaps the antenna 100 in the first direction. When the antenna 100 is in a working state, according to the Lenz's law, an induced current in a direction opposite to the current on the antenna 100 is inevitably generated in the metal material region. This affects working performance of the antenna 100. However, the non-closed slot 20 is also provided in the metal material region, so that adverse impact of the induced current on the antenna 100 can be reduced, and the working performance of the antenna 100 is enhanced to some extent.

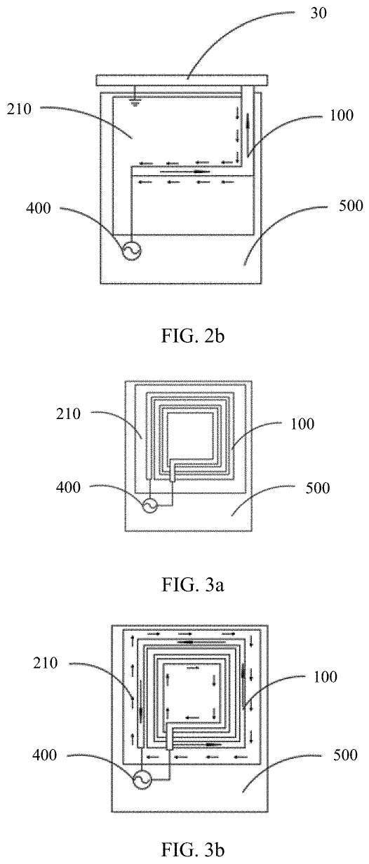

Refer to FIG. 2a, FIG. 2b, FIG. 3a, and FIG. 3b together. FIG. 2a is a schematic diagram of a structure of an antenna 100-related component in a conventional electronic device. FIG. 2b is a schematic diagram of current distribution on the antenna 100-related component shown in FIG. 2a. FIG. 3a is a schematic diagram of a structure of another antenna 100-related component in a conventional electronic device. FIG. 3b is a schematic diagram of current distribution on the antenna 100-related component shown in FIG. 3a.

As shown in FIG. 2a, the common near field communication antenna 100 generally has two forms. One form is a single-ended near field communication antenna 100 which is formed by combining a section of wiring with a metal frame 30 on the housing 300. The antenna 100, the metal structure 200, the mainboard 500, the radio frequency module 400, and the metal frame 30 on the housing 300 are disposed in the electronic device. The metal frame 30 is grounded, the radio frequency module 400 is disposed on the mainboard 500, one end of the antenna 100 is connected to the metal frame 30, and the other end is electrically connected to the radio frequency module 400 for performing feeding. The antenna and the metal frame 30 jointly form an enclosing structure. The enclosing structure forms unclosed enclosing space, and may be considered as a semi-enclosing structure or a partial enclosing structure. In this form of antenna 100, there are a plurality of structural variations. For example, in an embodiment, one end of the antenna 100 is grounded, and the other end is connected to the metal frame 30. The metal frame 30 is ungrounded, but is electrically connected to the radio frequency module 400.

As shown in FIG. 3a, another form is a coil near field communication antenna 100. The antenna 100 is circled and forms a coil form. The antenna 100, the metal structure 200, the mainboard 500, and the radio frequency module 400 are disposed in the electronic device. The radio frequency module 400 is disposed on the mainboard 500, and the antenna 100 is circled and forms an enclosing structure. The enclosing structure may form closed enclosing space, and may be considered as a fully enclosed enclosing structure. Certainly, the antenna may alternatively be circled and form a partial enclosing or semi-enclosing structure, to form non-closed enclosing space. Two ends of the antenna 100 are electrically connected to the radio frequency module 400. In this form of the antenna 100, there are also a plurality of structural variations.

In conclusion, the antenna 100 in this application forms the enclosing structure in the electronic device. The enclosing structure may be understood as a partial enclosing, semi-enclosing, or full enclosing structure, to form closed enclosing space or non-closed enclosing space. It may be understood that structural forms of the antenna 100 in this application include but are not limited to the foregoing two forms. For ease of description, the foregoing two forms of the near field communication antenna 100 are mainly used for a detailed description in this application. In addition, a structure of the antenna 100 may have a plurality of variant structures, provided that corresponding functions are met. Details of the plurality of variant structures are not described herein one by one.

It may be understood that, in a conventional electronic device, because the electronic device needs to meet market requirements of lightness, thinness, and miniaturization, a spacing between the metal structure 200 and the near field communication antenna 100 is small regardless of a form of the antenna 100. In addition, the metal structure 200, at least a part of the antenna 100, and a part of the housing 300 are sequentially arranged in a first direction. When the antenna 100 is in a working state, an induced current is generated on the metal structure 200. As shown in FIG. 2b and FIG. 3b, according to the Lenz's law, it can be learned that the induced current has a direction that a magnetic field of the induced current always hinders a change of a magnetic flux of the induced current. Therefore, a direction of the induced current generated on the metal structure 200 close to the antenna 100 is opposite to the direction of the current on the antenna 100. That is, one direction is an anticlockwise direction, and the other direction is a clockwise direction. The magnetic field generated by the induced current in the opposite direction offsets part of the magnetic field of the antenna 100. In this way, working performance of the antenna 100 is inevitably weakened to some extent.

Refer to FIG. 4a, FIG. 4b, and FIG. 4c together. FIG. 4a is a schematic diagram of a structure of an antenna 100-related component in the electronic device 1000 shown in FIG. 1a in an embodiment. FIG. 4b is a schematic diagram of a structure of the antenna 100-related component shown in FIG. 4a in another embodiment. FIG. 4c is a schematic diagram of an antenna projection region 202 and enclosing space 203 in the antenna 100-related component shown in FIG. 4b.

In the electronic device 1000 provided in this embodiment of this application, for the single-ended near field communication antenna 100, the metal structure 200 may be the metal support 210 made of a metal material. The slot 20 extending from an edge of the first surface 201 of the metal support 210 to the inside of the first surface 201 is disposed on the metal support 210. In a direction perpendicular to the first surface 201, the slot 20 penetrates through the metal support 210. In this structure, an edge of the slot 20 is connected to an edge of the metal support 210, so that the slot 20 is a non-closed slot 20, and the slot 20 passes through a vertical projection region of the antenna 100 on the first surface 201.

The vertical projection region of the antenna 100 on the first surface 201 is the antenna projection region 202. It may be understood that, regardless of the foregoing form of the antenna 100, a structure of the antenna 100 is an enclosing structure. When the antenna 100 is the enclosing structure, a corresponding signal transmission function can be better met. In this implementation, the metal frame 30 may be considered as an extension of the antenna 100. The antenna 100 and the metal frame 30 jointly form an enclosing structure. In a first direction, the antenna projection region 202 jointly formed by the antenna 100 and the metal frame 30 on the first surface 201 also forms the corresponding enclosing space 203.

The slot 20 passes through the antenna projection region 202, and the slot 20 is divided into a first segment 21, a second segment 22, and a third segment 23 by the antenna projection region 202. The first segment 21 is located between the antenna projection region 202 and an edge of the first surface 201, an edge of the first segment 21 is connected to the edge of the first surface 201, and is further connected to an edge of the metal support 210. The second segment 22 is located in the enclosing space 203 formed by the antenna projection region 202. In addition, the first segment 21 is connected to the second segment 22 by using the third segment 23. In other words, it may be understood that, when observed in a direction perpendicular to the first surface 201, the first segment 21 is located outside the antenna projection region 202, and the second segment 22 is located inside the antenna projection region 202. It should be noted that, on the metal support 210, generated induced currents are generally swirly distributed, and the closer to the antenna projection region 202, the stronger the induced current is. When the antenna 100 intercepts the slot 20, and the first segment 21 and the second segment 22 are respectively located on two sides of the antenna projection region 202, an induced current with high strength generated on the metal support 210 inevitably flows through the slot 20, and flows along two paths. One induced current flow path is flowing along the edge of the first segment 21 to the edge of the metal support 210, and then flowing along the edge of the metal support 210. The other current flow path is flowing along the edge of the second segment 22. It can be learned from continuity of a current that a current line in a current field is inevitably a closed curve in which a head and a tail are connected. Therefore, on the foregoing two paths, flow directions of the induced currents are consistent with a flow direction of the current on the antenna 100, that is, the directions are all clockwise directions or anticlockwise directions. In other words, in this structure, induced currents that are in a same direction as the current on the antenna 100 are generated at positions on the metal support 210 that are located inside and outside the antenna 100, and strength of the induced currents in the direction are strong. In this way, adverse impact of the induced current on a magnetic field of the antenna 100 is reduced, and working performance of the antenna 100 is effectively improved.

It may be understood that there may be a plurality of shapes and sizes of the slot 20. This is not specifically limited herein. A shape of the slot 20 is used as an example in the following descriptions.

As shown in FIG. 4b, the second segment 22 includes a connection part 221 and an extension part 222. The connection part 221 is connected between the third segment 23 and the extension part 222. The first segment 21, the third segment 23, and the connection part 221 jointly form a strip-shaped slot extending in a same direction. In an extension direction perpendicular to the strip-shaped slot, a size of the extension part 222 is greater than a size of the connection part 221. In the foregoing structure, the second segment 22 inside the antenna 100 has a large area. In this case, a path for flowing the induced current on the second segment 22 is longer, and a range of a magnetic field generated by the induced current is larger. It can be learned from the foregoing description that a flow direction of the induced current on the second segment 22 is the same as a flow direction of the current on the antenna 100. Therefore, when the range of the magnetic field generated by the induced current on the second segment 22 is larger, the antenna 100 has a better gain effect on the magnetic field of the antenna 100. In this way, working performance of the antenna 100 is further improved.

It may be understood that a shape and a size of the slot 20 may be set according to an internal structure requirement of the electronic device 1000, or may correspond to a shape and a size of the antenna 100. Impact of the metal support 210 on working performance of the antenna 100 may be adjusted by adjusting the shape and the size of the slot 20. The shape and the size of the slot 20 are not specifically limited herein.

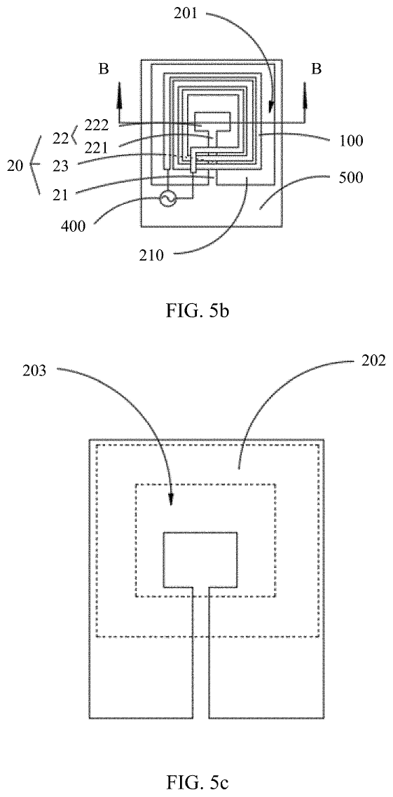

Refer to FIG. 5a, FIG. 5b, and FIG. 5c together. FIG. 5a is a schematic diagram of an antenna 100-related component in the electronic device 1000 shown in FIG. 1a in another embodiment.

FIG. 5b is a schematic diagram of a structure of the antenna 100-related component shown in FIG. 5a in another embodiment.

FIG. 5c is a schematic diagram of an antenna projection region 202 and enclosing space 203 in the antenna 100-related component shown in FIG. 5b.

In the electronic device 1000 provided in this embodiment of this application, for the coil near field communication antenna 100, the metal structure 200 may also be the metal support 210 made of a metal material, and the non-closed slot 20 extending from an edge of the metal support 210 to the inside of the metal support 210 is also disposed on the metal support 210. When an induced current generated on the metal support 210 close to the antenna 100 passes through the non-closed slot 20, the induced current flows along the edge of the slot 20 and the edge of the metal support 210, and a direction of the induced current flowing along the foregoing two paths is the same as a direction of the current on the antenna 100. In this way, adverse impact of the induced current on working performance of the antenna 100 is reduced.

It may be understood that, for the two forms of the structure of the antenna 100, in the antenna 100-related component:

The metal support 210 may have a same shape and structure.

A position state of the non-closed slot 20 on the metal support 210 is the same, that is, the slot 20 is disposed in a manner of extending from an edge of the first surface 201 to the inside of the first surface 201 on the metal support 210, and in a direction perpendicular to the first surface 201, the slot 20 penetrates through the metal support 210. In addition, the slot 20 passes through the antenna projection region 202 of the antenna 100 on the first surface 201, and the slot 20 is also divided by the antenna projection region 202 into the first segment 21, the second segment 22, and the third segment 23 that are connected. Similarly, the second segment 22 may be disposed as the connection part 221 and the extension part 222, to further improve working performance of the antenna 100.

Technical effects of the slot 20 are the same. To be specific, when an induced current generated on the metal support 210 close to the antenna 100 passes through the non-closed slot 20, the induced current flows along two paths: an edge of the slot 20 and an edge of the metal support 210. Directions of the induced currents flowing along the two paths are the same as a direction of the current on the antenna 100, that is, the directions are all clockwise directions or anticlockwise directions. In this way, interference of the induced current to a magnetic field of the antenna 100 is reduced, and working performance of the antenna 100 is effectively improved.

It can be learned that, for the two forms of the structure of the antenna 100, the metal support 210 and the slot 20 have a same implementation and a same function. Therefore, details are not described again. In addition, in an actual application process, when the antenna 100 is of an enclosing structure, a corresponding signal transmission function can be better satisfied. In this structure, the antenna projection region 202 of the antenna 100 on the first surface 201 inevitably forms enclosing space 203. When the extension part 222 extends beyond the enclosing space 203, an induced current generated by another metal in the enclosing space 203 cannot be offset, and working performance of the antenna 100 is weakened, to ensure that a magnetic field generated by an induced current on the metal support 210 has a better gain effect on the magnetic field of the antenna 100, and the extension part 222 should be located in the enclosing space 203.

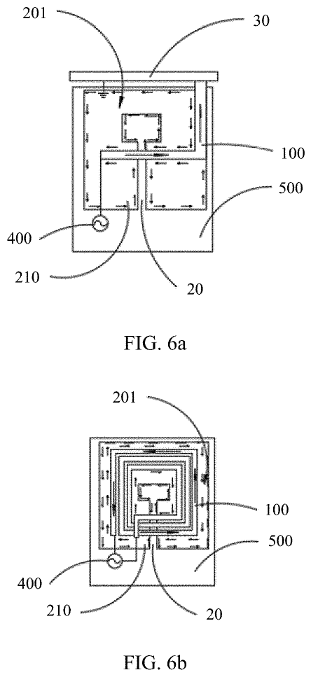

Refer to both FIG. 6a and FIG. 6b. FIG. 6a is a schematic diagram of current distribution on the antenna 100-related component shown in FIG. 4b.

FIG. 6b is a schematic diagram of current distribution on the antenna 100-related component shown in FIG. 5b.

As shown in the figure, an arrow direction is a flow direction of a current on the antenna 100 and an induced current on the metal support 210. It can be learned from the figure that, on the metal support 210, the induced current generated at the position close to the antenna 100 is dense and has strong strength. In addition, a direction of the induced current herein is opposite to the direction of the current on the antenna 100, which complies with the Lenz's law. When the induced current passes through the slot 20, due to continuity of the current, the induced current flows along two paths. One induced current flow path is flowing along an edge of the first segment 21 to an edge of the metal support 210, and then flowing along the edge of the metal support 210. The other current flow path is flowing along the edge of the second segment 22. On the foregoing two paths, a flow direction of the induced current is consistent with a flow direction of the current on the antenna 100, that is, both the directions are anticlockwise. In other words, in the electronic device 1000 provided in this embodiment of this application, induced currents in a same direction as the current on the antenna 100 are generated at positions on the metal support 210 that are located inside and outside the antenna 100. By comparing FIG. 2b with FIG. 3b, it can be clearly illustrated that the non-closed slot 20 on the metal support 210 can change a flow direction of a part of the induced current on the metal support 210. In this way, adverse impact of the induced current on a magnetic field of the antenna 100 is reduced, and working performance of the antenna 100 is effectively improved.

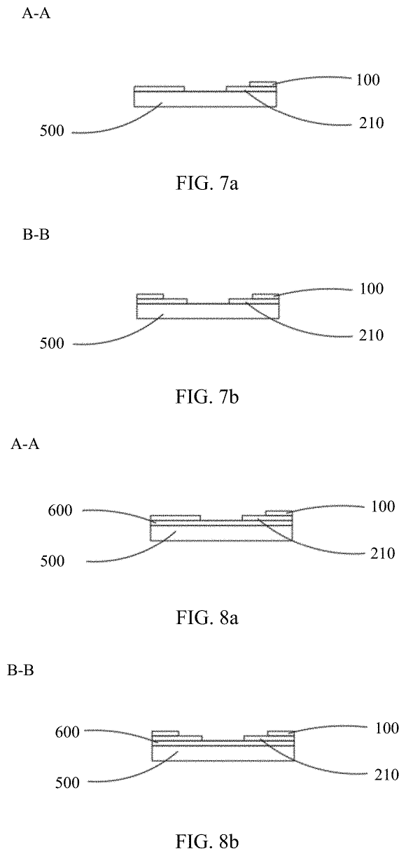

Refer to FIG. 7a, FIG. 7b, FIG. 8a, and FIG. 8b together. FIG. 7a is a sectional view of the antenna 100-related component shown in FIG. 4b in an A-A direction.

FIG. 7b is a sectional view of the antenna 100-related component shown in FIG. 5b in a B-B direction.

FIG. 8a is a schematic diagram of a structure when a magnetic piece 600 is applied to the antenna 100-related component shown in FIG. 7a.

FIG. 8b is a schematic diagram of a structure when a magnetic piece 600 is applied to the antenna 100-related component shown in FIG. 7b.

In an embodiment, the electronic device 1000 provided in this embodiment of this application further includes a magnetic piece 600. The magnetic piece 600 is disposed at a position that is of the metal support 210 and that is away from the antenna 100. The metal support 201 is located between the antenna 100 and the magnetic piece 600, so that the metal support 201 is isolated from another metal piece in the electronic device 1000. The magnetic piece 600 is disposed at a position that is of the metal support 210 and that is away from the antenna 100, and is mainly configured to isolate the metal support 210, so as to prevent the metal support 210 from being connected to another metal piece. It may be understood that if the metal support 210 is connected to another metal piece, the metal support 210 and the another metal piece jointly form an integer, and the slot 20 on the original metal support 210 may be filled by the another metal piece, alternatively, the slot 20 becomes a closed slot 20 due to a structure change, or the slot 20 cannot change a direction of an induced current due to some other reasons. As a result, adverse impact on working performance of the antenna 100 cannot be avoided.

The magnetic piece 600 is made of ferrite, and the ferrite is a metal oxide having a ferromagnetic property. In terms of an electrical property, the ferrite has resistivity much larger than that of metal and alloy magnetic materials, and has a higher dielectric property. The magnetic property of the ferrite also shows that it has high magnetic permeability on a high frequency. Therefore, the ferrite has become a widely used nonmetallic magnetic material in the field of high frequency and weak current. According to the formula B=μ·H, B represents magnetic induction intensity, μ represents magnetic permeability, and H represents magnetic field intensity. When the magnetic field intensity H remains unchanged, because the magnetic permeability μ of the ferrite is generally large, the magnetic induction intensity B of the ferrite is large. This indicates that the ferrite has a gathering function on a magnetic field. Therefore, the magnetic piece 600 can not only isolate the magnetic field, but also can gather the magnetic field. It should be noted that the magnetic piece 600 is not limited to being made of ferrite, and may also be made of any other magnetic material that meets a corresponding function requirement. This is not specifically limited herein.

It should be noted that, according to different working principles of the antenna 100, when the antenna 100 with different working frequency bands is in a corresponding working frequency band, requirements for the metal support 210 are also different, for example, the metal support 210 is suspended and not connected to the mainboard 500, and the metal support 210 is grounded. Generally, for some antennas 100 with a low operating frequency band, that is, the antenna 100 with an operating frequency band less than 100 M, for example, the near field communication antenna 100, when the antennas 100 works, radiation needs to be performed by using metal. Therefore, when the antenna 100 is in its operating frequency band, the metal support 210 is required to be suspended and not connected to the mainboard 500. When the metal support 210 is not suspended and connected to the mainboard 500, the metal support 210 becomes a ground plane, so that a radiation effect cannot be achieved, and the antenna 100 cannot be in a normal working state. For the antenna 100 with a high operating frequency band, that is, the antenna 100 whose operating frequency band is greater than 500 M, when the antenna 100 is in its operating frequency band, for example, the 2G frequency band, the 3G frequency band, the 4G frequency band, the 5G frequency band, the Wi-Fi frequency band, the GPS frequency band or the like, the metal support 210 is required to be grounded. When the antenna is in the high frequency band, if the metal support 210 is suspended and ungrounded, working performance of the antenna 100 corresponding to the metal support is affected to some extent. Therefore, the metal support 210 needs to be grounded, so that the metal support 210 is used as a ground plane. In this way, impact of the metal support on the antenna 100 with the high operating frequency band is avoided.

Therefore, to meet the foregoing different cases, connection relationships between the metal support 210 and the mainboard 500 are also different.

In an embodiment, the metal support 210 is disposed between the mainboard 500 and the antenna 100 in a stacked manner, the magnetic piece 600 is disposed between the mainboard 500 and the metal support 210, and a suspended ungrounded architecture is formed between the metal structure and the mainboard. In this structure, the metal support 210 and the mainboard 500 are disposed at intervals, the metal support 210 is not connected to the mainboard 500, and the metal support 210 is suspended and ungrounded, so as to meet requirements of some low-band antennas 100 for the metal structure 200 in corresponding operating frequency bands.

In an embodiment, the mainboard 500 includes a ground plane (not shown in the figure), the metal support 210 is disposed between the mainboard 500 and the antenna 100 in a stacked manner, a magnetic piece 600 is disposed between the mainboard 500 and the metal support 210, and a filter (not shown in the figure) is further disposed between the mainboard 500 and the metal support 210. The metal support 210 is connected to the ground plane by using the filter. The filter has different resistance features in different frequency bands, so that in different operating frequency bands of the antenna 100, the metal support 210 is correspondingly connected to or disconnected from the ground plane of the mainboard 500. When the filter is in a frequency band less than 100 M, the filter has a high resistance feature, so that the metal support 210 is not connected to the mainboard 500, to meet requirements of some low-band antennas 100 on the metal support 210 in corresponding operating frequency bands. When the filter is in a frequency band greater than 500 M, the filter has a low resistance feature, so that the metal support 210 is connected to the ground plane of the mainboard 500, and the metal support 210 is grounded, to meet requirements of some high-band antennas 100 on the metal support 210 in corresponding operating frequency bands.

It may be understood that, in this embodiment, an operating frequency band of the low-band antenna 100 is defined to be less than 100 M, and an operating frequency band of the high-band antenna 100 is defined to be greater than 500 M. For different operating cases, the low frequency band and the high frequency band may be divided differently, so as to perform different processing by using different features of different frequency bands. In addition, the filter may be any shape or structure that meets a corresponding function requirement. This is not specifically limited herein either.

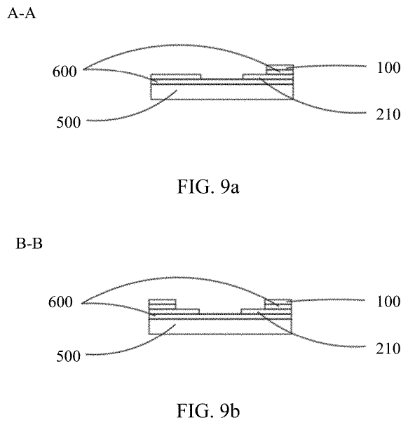

Refer to FIG. 9a and FIG. 9b together. FIG. 9a is a schematic diagram of a structure of the antenna 100-related component shown in FIG. 8a in an embodiment.

FIG. 9b is a schematic diagram of a structure of the antenna 100-related component shown in FIG. 8b in an embodiment.

In an embodiment, the magnetic piece 600 is further disposed between the antenna 100 and the metal support 210. The magnetic material is disposed between the antenna 100 and the metal support 210, and a magnetic field gathering function of the magnetic piece 600 is mainly used. After the magnetic piece 600 is additionally disposed at the position, a magnetic field is mainly gathered on the magnetic piece 600, and a closed curve is formed after the magnetic field passes through the magnetic piece 600. The magnetic piece 600 is disposed between the antenna 100 and the metal support 210, so that the magnetic field can be gathered, and impact of the metal support 210 on the magnetic field of the antenna 100 is reduced. In this way, the antenna 100 is ensured to have good working performance. Because the magnetic piece 600 is disposed between the antenna 100 and the metal support 210, the magnetic field gathering function of the magnetic piece 600 is mainly used instead of an isolation function of the magnetic piece 600. Therefore, the magnetic piece 600 herein does not need to cover and isolate the entire metal support 210. In a specific implementation, a shape and a size of the magnetic piece 600 between the antenna 100 and the metal support 210 match a shape and a size of the antenna 100, to reduce costs. In this way, the magnetic piece 600 covers only a region in which the antenna 100 is located. In this structure, the magnetic piece 600 can gather a magnetic field, thereby reducing adverse impact of the metal support 210 on the antenna 100. In addition, a coverage area of the magnetic piece 600 is further controlled, thereby reducing process costs.

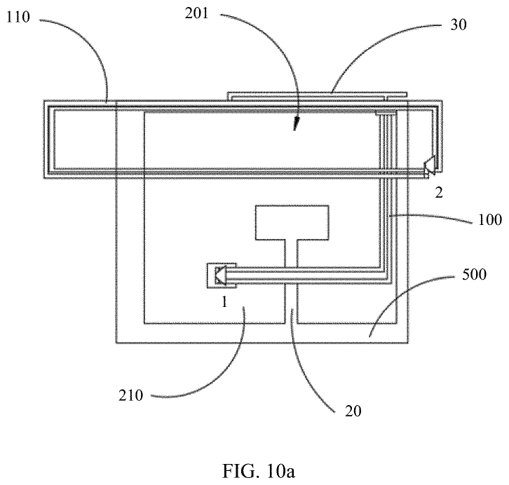

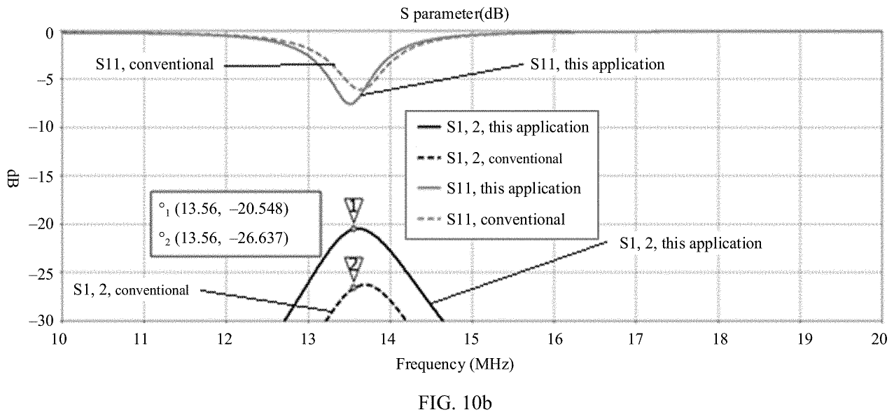

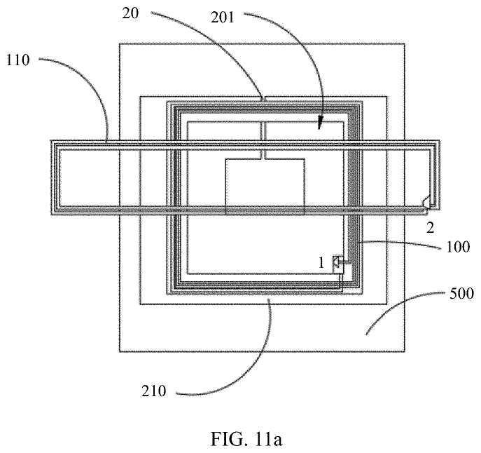

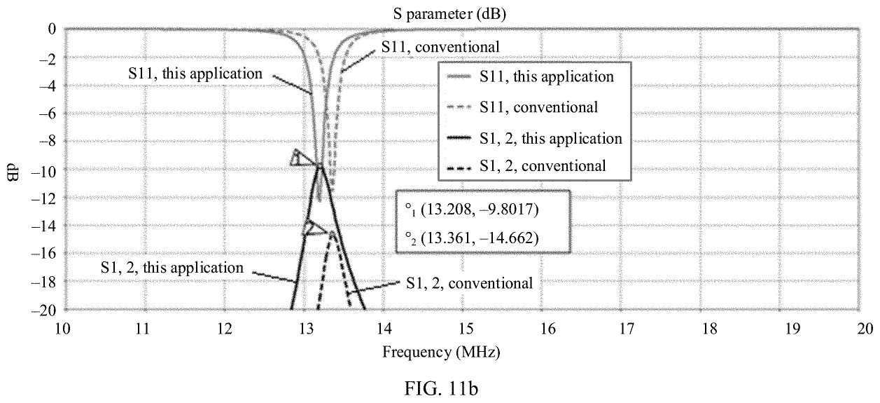

Refer to FIG. 10a, FIG. 10b, FIG. 11a, and FIG. 11b together. FIG. 10a is a diagram of transmission coefficient simulation performed by using the antenna 100-related component in FIG. 9a.

FIG. 10b is a diagram of comparison between transmission coefficient results in FIG. 10a.

FIG. 11a is a diagram of transmission coefficient simulation performed by using the antenna 100-related component in FIG. 9b.

FIG. 11b is a diagram of comparison between transmission coefficient results in FIG. 11a .

A coil-coupled antenna 110 is disposed on the antenna 100, and a magnitude of a signal transmitted from a first port on the antenna 100 to a second port on the coil-coupled antenna 110 is tested, to compare working performance of the antenna 100 in the conventional electronic device with that of the antenna 100 in the electronic device 1000 provided in this embodiment of this application. It can be learned from FIG. 10b and FIG. 11b that a transmission coefficient S1, 2 of the antenna 100 in the electronic device 1000 in this application is greater than a transmission coefficient S1, 2 of the antenna 100 in the conventional electronic device. In other words, working performance of the antenna 100 in the electronic device 1000 in this application is better than working performance of the antenna 100 in the conventional electronic device. Therefore, it is further noted that the non-closed slot 20 on the metal support 210 can change a flow direction of a part of an induced current on the metal support 210. In this way, adverse impact of the induced current on a magnetic field of the antenna 100 is reduced, and working performance of the antenna 100 is effectively improved.

It may be understood that in the electronic device 1000 provided in this embodiment of this application, the metal structure 200 includes but is not limited to the metal support 210 made of a metal material, or may be a metal material on the mainboard 500, a metal material on the camera housing 71, a metal material on the metal shielding case 800, or a metal material on any component. This is not specifically limited herein.

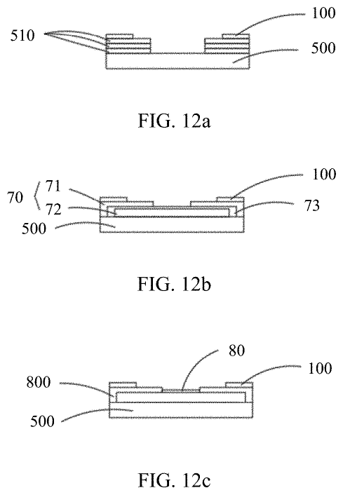

Refer to FIG. 12a, FIG. 12b, and FIG. 12c together. FIG. 12a is a schematic diagram of a structure of a metal structure 200 in an electronic device 1000 according to an embodiment of this application.

FIG. 12b is a schematic diagram of a structure of a metal structure 200 in an electronic device 1000 according to an embodiment of this.

FIG. 12c is a schematic diagram of a structure of a metal structure 200 in an electronic device 1000 according to an embodiment of this application.

As shown in FIG. 12a, the mainboard 500 is of a multi-layer structure. When the mainboard 500 has a plurality of ground planes 510 made of a metal material, the plurality of ground planes 510 are the metal structure 200 in the electronic device 1000 in this application. In this structure, slot 20 processing needs to be performed on each ground plane 510, so as to ensure that an induced current on the ground plane 510 does not greatly affect working performance of the antenna 100. In addition, after slot 20 opening is performed on the mainboard 500, a required component may be placed in a non-slot 20 region on the mainboard 500. This can also meet a corresponding function requirement, and does not affect another function of the electronic device 1000.

As shown in FIG. 12b, the electronic device 1000 further includes a camera module 70. The camera module 70 includes a camera housing 71 and a camera body 72. The camera housing 71 includes a metal material (not shown in the figure). Under the same reason as that described in the foregoing implementation, existence of the metal material on the camera housing 71 causes adverse impact on working performance of the antenna 100. In this case, a non-closed slot body extending from an edge of the metal material to the inside of the metal material needs to be provided on the metal material, to form the slot 20. The slot 20 can ensure that working performance of the antenna 100 is not weakened, and is further enhanced to some extent. It may be understood that, in some cases, the camera housing 71 may be integrally made of a metal material. In these cases, the camera housing 71 is integrally the metal structure 200 in the electronic device 1000 in this application. To prevent an induced current generated on the camera housing 71 from adversely affecting working performance of the antenna 100, a non-closed slot body extending from an edge of the camera housing 71 to the inside of the camera housing 71 needs to be disposed on the camera housing 71, to form the slot 20. In this way, working performance of the antenna 100 is prevented from being adversely affected. It should be noted that, in order to avoid impact on a photographing function of the camera, slot 20 processing may not be performed on the camera body 72 inside the camera housing 71. However, in order to avoid impact on the antenna 100 caused by the camera body 72, insulation processing should be performed between the camera housing 71 and the camera body 72, for example, an insulation material 73 is disposed. In this way, the photographing function of the camera is not affected, and the working performance of the antenna 100 is not adversely affected.

As shown in FIG. 12c, the electronic device 1000 further includes the metal shielding case 800. The metal shielding case 800 includes a metal material (not shown in the figure), and the metal material is the metal structure 200. A non-closed slot body extending from an edge of the metal material to the inside of the metal material is disposed on the metal material, to form the slot 20. The metal shielding case 800 is configured to shield impact of an external electromagnetic wave on an internal circuit and/or shield radiation of an electromagnetic wave generated inside. Generally, the metal shielding case 800 is integrally made of stainless steel and a copper-nickel-zinc alloy. Therefore, the metal shielding case 800 is usually the metal structure 200 in the electronic device 1000 in this application. Anon-closed slot body extending from an edge of the metal shielding case 800 to the inside of the metal shielding case 800 is disposed on the metal shielding case 800, to form the slot 20, so that an induced current is generated on the metal shielding case 800 close to the antenna 100. When the induced current passes through the slot 20, due to continuity of a current, the induced current flows along the edge of the slot 20 and the edge of the metal shielding case 800 respectively, and a direction of the induced current flowing along the edge of the slot 20 and the edge of the metal shielding case 800 is the same as a direction of the current on the antenna 100. In this way, adverse impact of the induced current on a magnetic field generated by the current on the antenna 100 is avoided, and good working performance of the antenna is ensured. It should be noted that, opening the slot 20 on the metal shielding case 800 inevitably affects shielding performance of the metal shielding case 800 to some extent. Therefore, a non-metal shield layer 80 needs to be disposed at the slot 20 on the metal shielding case 800, and the non-metal shield layer 80 is connected to the metal shielding case 800 and covers the slot 20. In this way, a shielding effect of the metal shielding case 800 can be ensured, and the adverse impact on working performance of the antenna 100 can be avoided.

1-12. (canceled)

13. An electronic device, wherein the electronic device comprises a housing, and an antenna and a metal structure accommodated in the housing, wherein the metal structure, at least a part of the antenna, and a part of the housing are sequentially arranged in a first direction; the antenna is attached to the metal structure, or an insulation medium exists between the metal structure and the antenna; the metal structure includes a slot, and the slot penetrates through the metal structure in the first direction; and the metal structure comprises a first surface facing the antenna in the first direction, a vertical projection of the antenna on the first surface is an antenna projection region, and the slot extends from an edge of the metal structure on the first surface to an inside of the first surface, and into the antenna projection region.

14. The electronic device according to claim 13, wherein in a working state of the antenna, an induced current that is in a same direction as a current on the antenna is formed on the first surface.

15. The electronic device according to claim 13, wherein the antenna projection region forms an enclosing space, and a part of the slot is located in the enclosing space.

16. The electronic device according to claim 13, wherein edges of the part of the slot that extends into the antenna projection region are all located inside the antenna projection region.

17. The electronic device according to claim 15, wherein the part of the slot located in the enclosing space comprises a connection part and an extension part, the connection part extends between an inner edge of the antenna projection region and the extension part, and in an extension direction perpendicular to the connection part, a size of the extension part is greater than a size of the connection part.

18. The electronic device according to claim 17, wherein the slot comprises a first segment, a third segment, and a second segment that are sequentially connected, the first segment is located between the antenna projection region and the edge of the metal structure on the first surface, the third segment is located in the antenna projection region, the second segment is located in the enclosing space, the second segment comprises the connection part and the extension part, the connection part is connected between the third segment and the extension part, and the first segment, the third segment, and the connection part are all in a straight line shape and are collinear.

19. The electronic device according to claim 17, wherein edges of the extension part are all located inside the antenna projection region.

20. The electronic device according to claim 13, wherein the electronic device further comprises an electronic component, and the metal structure is disposed between the antenna and the electronic component.

21. The electronic device according to claim 13, wherein a mainboard is disposed inside the electronic device, and the metal structure is a ground plane on the mainboard.

22. The electronic device according to claim 13, wherein a camera module is disposed inside the electronic device, the camera module comprises a camera housing and a camera body that is located inside the camera housing, the metal structure is the camera housing, and an insulation material is disposed between the camera housing and the camera body.

23. The electronic device according to claim 13, wherein a metal shielding case and a non-metal shielding layer are disposed inside the electronic device, the metal shielding case is configured to shield an electronic component, the metal structure is the metal shielding case, and the non-metal shield layer is connected to the metal shielding case and covers the slot.

24. The electronic device according to claim 13, wherein the electronic device further comprises a magnetic piece, and the magnetic piece is disposed on a side of the metal structure and is away from the antenna.

25. The electronic device according to claim 13, wherein the electronic device further comprises a mainboard, the metal structure is disposed between the mainboard and the antenna in a stacked manner, a magnetic piece is disposed between the mainboard and the metal structure, and a suspended ungrounded architecture is formed between the metal structure and the mainboard.

26. The electronic device according to claim 13, wherein the electronic device further comprises a mainboard, the metal structure is disposed between the mainboard and the antenna in a stacked manner, a magnetic piece is disposed between the mainboard and the metal structure, the metal structure is electrically connected to a ground plane of the mainboard by a filter component, and the filter component has a high resistance feature in an operating frequency band of the antenna.

27. The electronic device according to claim 15, wherein the electronic device further comprises a metal frame, and the antenna and the metal frame together jointly form the enclosing structure, which is an unclosed enclosing space.

28. The electronic device according to claim 27, wherein the metal frame is grounded, one end of the antenna is electrically connected to the metal frame, and the other end is electrically connected to a radio frequency module of the electronic device.

29. The electronic device according to claim 27, wherein one end of the antenna is grounded, and the other end is electrically connected to the metal frame, and wherein the metal frame is ungrounded, and is electrically connected to a radio frequency module of the electronic device.

30. The electronic device according to claim 15, wherein the antenna is a circled coil, and the antenna forms the enclosing structure which is a closed enclosing space.
